(19) United States
(12) Patent Application Publication
(10) Pub. No.: US 2015/0025941 A1
(43) Pub. Date: Jan. 22, 2015

(54) METHODS AND SYSTEMS FOR MANAGING PRODUCT TEST ORDER TRACKING, REPORTING, AND PRODUCT DISPOSITION

(71) Applicant: Bureau Veritas, Neuilly sur Seine (FR)

(72) Inventors: Chetan Rao, Hong Kong (HK); Rohit Kamat, Hong Kong (HK); Dan Rydelek, Lewiston, NY (US); Jason Watrous, Williamsville, NY (US)

(21) Appl. No.: 13/942,839

(22) Filed: Jul. 16, 2013

(51) Int. Cl. G06Q 10/06

(52) U.S. Cl. CPC G06Q 10/06393
USPC 705/7.39

(57) ABSTRACT

A method and system for collecting and managing data of test orders of a number of different service types, and presenting in a plurality of different formats the up-to-date data, status, and results of the test orders. Such method and system can be an integral part of product manufacturing, logistic, and/or quality control and assurance processes. Such method and system can filter, organize, and generate from the test order records a plurality of different types of reports organized by the characteristics of the information recorded in the reports, wherein the characteristics include, but not limited to, granularity of the information, request dates, service dates, and report dates of the test orders, service types, product items, product categories, industries, suppliers, factories, factory countries, product and process dispositions associated with the test orders, statuses, and results of the test orders.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to information systems used in product manufacturing, testing, quality control, quality assurance, logistics, and safety and regulation compliance certification processes. Particularly, the present invention relates to methods and systems for managing, collecting, and presenting data pertaining to product test order tracking, reporting, and product and process disposition during testing of the product.

### BACKGROUND

To achieve scale of economy and cost efficiency, finished goods are often marketed, sold, and used in more than one economic or geographical market without extensive redesign for each market. This means that the goods must be designed to meet diverse sets of regulatory requirements in multiple jurisdictions at the time when the goods are imported into these markets. For example, a mobile communication device being sold in the United States and the European Union might have to meet the regulatory requirements set out by the Federal Communications Commission (FCC) in the U.S., the U.S. Consumer Product Safety Improvement Act (CPSIA), the Waste Electrical and Electronic Equipment Directive (WEEE) and the Restriction of Hazardous Substances Directive (RoHS) in the European Union. In addition, modern product manufacturing supply chains can span across multiple countries.

This means all components that might be sourced from multiple different countries must also be designed and manufactured to meet these regulatory requirements. Furthermore, products being imported and sold in different countries must have their samples tested, inspected, and/or factories audited, periodically in some cases, for compliance of the regulations in those countries. In some cases, a product that comprises multiple components sourced from multiple suppliers will also need to pass such compliance tests at the component level. Therefore, there is a need for a tool or a method that allow the management of compliance testing, collection and reporting of test data, as well as the product and process disposition during compliance product testing, inspection, and factory auditing.

### SUMMARY

It is an objective of the presently claimed invention to provide a method and system that collect and manage data of test orders of a number of different service types, and present in a plurality of different formats the up-to-date data, status, and results of the test orders. Such method and system can be an integral part of product manufacturing, logistic, and/or quality control and assurance processes.

It is a further objective to provide such method and system that can filter, organize, and generate from the test order records a plurality of different types of reports organized by the characteristics of the information recorded in the reports, wherein the characteristics include, but not limited to, granularity of the information, request dates, service dates, and report dates of the test orders, service types, product items, product categories, industries, suppliers, factories, factory countries, product and process dispositions associated with the test orders, statuses, and results of the test orders.

The primary service types of test order comprise product test, supplier inspection, factory assessment, social audit, and security audit. Each test order can be further defined with conditions including, but not limited to, initial, follow-up, repeated, cycle, annual, final, and during-production test/inspection/assessment/audit.

### BRIEF DESCRIPTION OF THE DRAWINGS

Embodiments of the invention are described in more detail hereinafter with reference to the drawings, in which

FIG. 1A shows an exemplary embodiment of a supplier scorecard generated by the presently claimed test order management system;

FIG. 1B shows an exemplary embodiment of a detail individual supplier scorecard generated by the presently claimed test order management system;

FIG. 2 shows an exemplary embodiment of a user interface provided by the presently claimed test order management system facilitating the specification of search filters in the generation of supplier scorecards; and

FIG. 3 shows an exemplary embodiment of a benchmark report generated by the presently claimed test order management system.

### DETAILED DESCRIPTION

In the following description, test order management methods and systems for collecting and managing data of test orders of a number of different service types, and present in a plurality of different formats up-to-date data, status, and results of the test orders and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to various embodiments, a user of the presently claimed test order management system, through the use of a client computing device, makes requests for presentment or submission of data of test order records to a server application running in a processing server or cluster of processing servers to be displayed on the client computing device.

The client computing device can be a conventional general purpose desktop or mobile computer, personal digital assistant, smart mobile phone, or any computing device with graphics display capability and is capable of processing computer data signals conforming to common data transmission protocols such as TCP/IP, HTTP, and HTML. The requests and responses between the client computing device and the processing server or cluster of processing servers is transmitted through wired and/or wireless communication medium. One such communication medium is the Internet.

The server application running at the processing server or cluster of processing servers collects from other internal and/or external processing servers for test order data and preserves these test order data in a data repository, which can be residing in one or more of the processing server or cluster of processing servers or a separate processing server or cluster of processing servers. The user interacts with the client computing device through a user interface of the test order management system. In accordance to various embodiments, such user interface can be an Internet browser application or a custom application running in the client computing device displaying one or more web applications or web pages hosted and executed by the processing server or cluster of processing servers.

In accordance to various embodiments, data of a test order comprises request date, service date, report date, order received data, estimated report due date, and confirmed date of the test orders, service type, one or more product items, one or more product categories, one or more industries, one or more suppliers, one or more factories, one or more factory countries, one or more product and process dispositions associated with the test orders, status, and result of the test order.

The main service types of test order comprise product test, supplier inspection, factory assessment, social audit, and security audit. Each service type can be further defined into initial, follow-up, repeated, cycle, annual, final, and during-production test/inspection/assessment/audit.

A product test encompasses testing on product samples to determine whether a product meets the specifications set by a client user of the test order management system and/or regulatory requirements.

A supplier inspection involves inspecting items at place(s) of manufacture at a supplier user of the test order management system before delivery. This is the most convenient and cost-effective way to determine whether a product, service, process, item of equipment or installation complies with expressed needs, customer expectations, applicable regulations or other specific requirements. Supplier inspection services encompass the verification of adherence to a client user's specified standards and specification, throughout the equipment manufacture from receipt of raw materials through manufacture, performance and safety testing, to preparation for shipping to a client user's receiving site.

A factory assessment is an assessment of the production capability and performance of a factory against proven quality principles. As such, the key criteria assessed are policies, procedures and records that would indicate the factory's ability to deliver consistent quality management over time, rather than at one given time or only for certain products. Core areas and processes addressed by a factory assessment include quality management system, manufacturing practice, product control, process control, and personnel.

As companies expand their manufacturing and sourcing capabilities around the world, supply chain workplace conditions are increasingly scrutinized. The lack of a process for managing social compliance risks can have a direct impact on financial results, especially for organizations in consumer markets where brand image is a critical asset. A social audit is audit conducted to a client user of the test order management system's own code of conduct or to industry codes as established by organizations such as the Fair Labor Association (FLA), the International Council of Toy Industries (ICTI), Worldwide Responsible Apparel Production (WRAP), International Labor Organization (ILO), SEDEX or SA 8000 (Social Accountability).

In accordance to various embodiments, the test order management system filters, organizes, and generates from the collected and preserved data of test order records a plurality of different types of reports organized by the characteristics of the information recorded in the reports, wherein the characteristics include, but not limited to, granularity of the information, dates of the test orders, service types, product items, product categories, industries, suppliers, factories, factory countries, product and process dispositions associated with the test orders, statuses, and results of the test orders. The different types of reports comprise client user's test order report, supplier score report, benchmarking report, and failure analysis report.

Through the use of a series of user interfaces provided by the test order management system, a client user can submit requests for new test orders, search, retrieve, view, and edit pending and completed test orders requested by her, and request for generations of reports. In addition, the client user can submit a product and process disposition to a completed test order. The product and process disposition can be overriding and accepting failure in result of the completed test order, requesting for a re-execute of the completed test order, or confirming result of the completed test order. A tester user can view and update test orders with statuses and test results when the test orders are executed and completed. A supplier user can view and update test orders associated with the supplier with limited accessibility. Furthermore, a supplier user can submit a corrective action plan to a completed test order associated with it with a failing result. The corrective action plan can be rectification of a product not that is not compliant with specification or regulatory standard, correction of a manufacturing practice that is not meeting guidelines or regulatory requirements, and/or reconfiguration of a factory or instrument that is causing the failure.

In accordance to one aspect of the presently claimed invention, the test order management system provides a supplier score report (“supplier scorecard”) by computing resulting scores and weighted resulting scores of one or more completed test orders associated with one or more suppliers selected by a user of the test order management system. The supplier scorecard is a means to rate the performance of a supplier. The supplier's scores are determined from the aggregated scores of completed test orders of each service type associated with the supplier. In general, a supplier with higher passing percentage in its completed test orders of a particular service type would have higher score in that service type than another supplier with lower passing percentage.

In accordance to one embodiment, an un-weighted score is computed for each service type (product test, supplier inspection, factory assessment, social audit, and security audit) based on the pass/fail results of completed test orders of that service type. A pre-determined weightage is assigned to each service type. The weightages are percentage values for multiplying with the respective regulatory requirement service type scores resulting in weighted service type scores. The sum of all weightages is 100%. The overall weighted score of a supplier is the sum of the weighted service type scores.

In another embodiment, one or more service type scores are further augmented by product/process-disposition-weighted scores by multiplying the un-weighted service type score with its corresponding pre-determined product/process disposition weightage. The overall product/process-disposition-weighted score of a supplier is the sum of the product/process-disposition-weighted service type scores. A product/process disposition weightage for a particular service type can be zero to indicate that service type score is not used in the calculation of the supplier's overall product/process-disposition-weighted score.

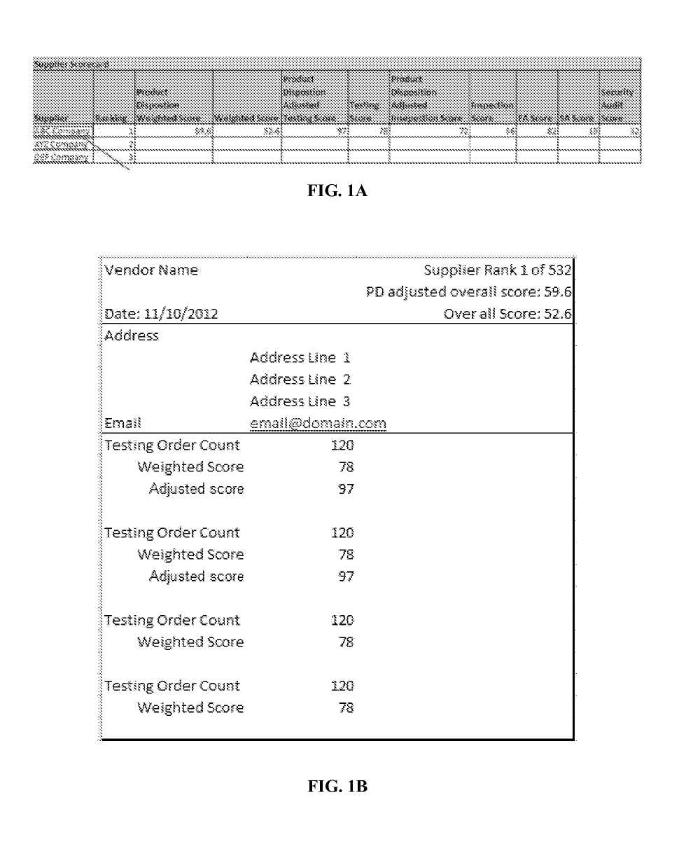

Through the use of the user interface of the test order management, a client user can request the generation of a supplier scorecard with multiple suppliers. In the supplier scorecard, the suppliers are ranked by their weighted/un-weighted product/process-disposition-weighted overall scores or scores in any service type as specified by the client user. The client user can further request the generation of more detailed supplier scorecard on individual supplier. Details shown include, but not limited to, the product/process-disposition-weighted scores, weighted scores, un-weighted scores, and the number of test orders considered. FIG. 1A and FIG. 1B show an exemplary embodiment of a supplier scorecard and detail individual supplier scorecard respectively.

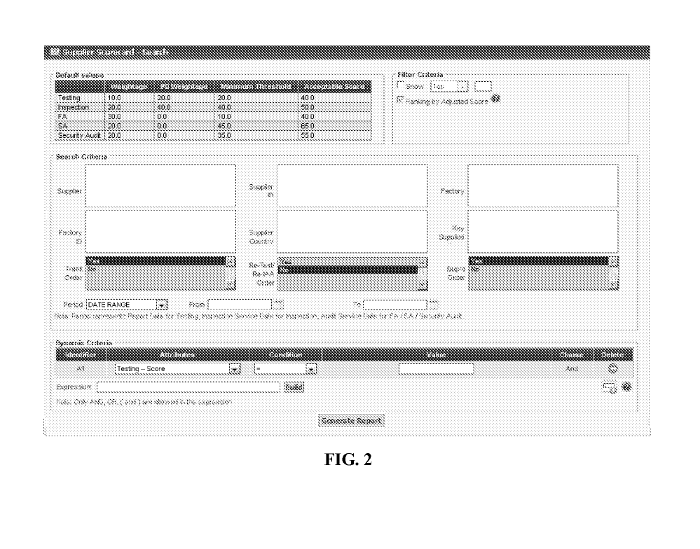

The generation of the supplier scorecard can have its scope of considered test order records refined and limited by a number of search filter parameters including, but not limited to, report dates and date ranges of the test orders, service dates and date ranges of the test orders, certain suppliers that the test orders are associated with, certain supplier country(ies), suppliers with certain factory country(ies), and inclusion/exclusion of test order condition (initial, follow-up, repeated, cycle, annual, final, and during-production). In addition, further filtering of the suppliers listed and/or test orders considered in the generation of the supplier scorecard can be achieved by specifying a minimum threshold score and/or an acceptable score for each service type such that suppliers that receive scores below these scores will not be listed in the supplier scorecard or be listed separately. FIG. 2 shows an exemplary embodiment of a user interface provided by the test order management system facilitating the specification of search filters in the generation of supplier scorecards.

In accordance to another aspect of the presently claimed invention, the test order management system provides a benchmark report, which allows a client user of the test order management system to compare its completed test order results of certain service type(s) and within certain product category(ies) with those of other client users, the industry averages, and national/regional averages. The resulting scores of completed test orders are computed based on the pass/fail results of completed test orders requested by the client user.

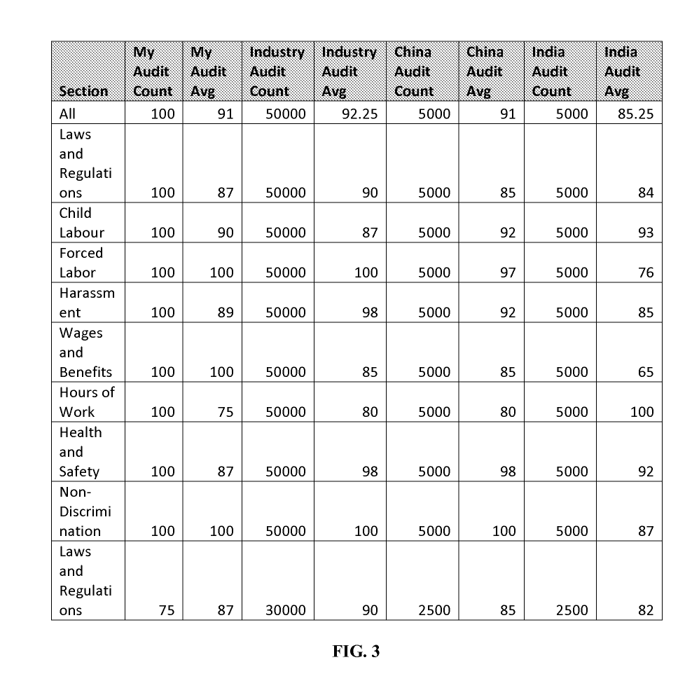

Through the use of the test order management system user interface, the client user can specify the service type(s), product category(ies), factory country(ies), and report dates or date ranges of the test orders, service dates or date ranges of the test orders for the generation of a benchmark report. In addition, the client user can specify to display the sub-scores and the corresponding industry averages and national/regional averages of selected section(s) of tests/inspection/assessments/audits of certain applicable service type(s). FIG. 3 shows an exemplary embodiment of a benchmark report generated with the selection of test orders of all product categories, all factory countries, social audit service type, and with service dates that fall within the prior year from the present (year to date). All social audit sections of the test orders are also shown in this exemplary benchmark report.

The embodiments disclosed herein may be implemented using general purposed or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for managing testing and auditing in a supply chain, comprising:
receiving, by a processing server, data of a test order requested by a client user from a client computing device; and
preserving, in a data repository, the data of the test order;
wherein the data of the test order comprising dates of the test order, service type, product item, product category, supplier, and factories associated with the test order;
wherein the service type being a product test, a supplier inspection, a factory assessment, a social audit, or a security audit; and
wherein the dates of the test order comprising request date of the test order, service date of the test order, and report date of the test order.

2. The method of claim 1, further comprising:
generating, by the processing server, reports from data of a plurality of test orders by characteristics of information recorded in the data; and
presenting, by the processing server, the generated reports in a user interface to be displayed in the client computing device connected to the processing server.

3. The method of claim 1, further comprising:
sending, by the processing server, the data of the test order to one or more testers to execute the test order to completion;
receiving, by the processing server, results of completed test orders from the testers; and
preserving, in the data repository, the results of the completed test orders.

4. The method of claim 1, further comprising:
receiving, by the processing server, data of a product and process disposition to a completed test order requested by the client user from the client computing device, wherein the product and process disposition is selected from disposition options comprising overriding and accepting failure in result of the completed test order, requesting for a re-execute of the completed test order, and confirming result of the completed test order.

5. The method of claim 1, further comprising:
computing, by the processing server, resulting scores and weighted resulting scores of one or more completed test orders associated with one or more suppliers selected by the client user; and
generating, by the processing server, a supplier score report from the data of the one or more completed test orders;
wherein the supplier score report showing the resulting scores and weighted resulting scores of one or more completed test orders associated with one or more suppliers selected by the client user.

6. The method of claim 5, wherein each of the resulting scores is computed based on results of the one or more completed test orders of a service type, and wherein each of the weighted resulting scores is the product of one of the resulting scores and its respective pre-determined weightage.

7. The method of claim 5, further comprising:
computing, by the processing server, overall scores and overall weighted scores of the one or more suppliers selected by the client user using the resulting scores and weighted scores of one or more completed test orders associated with the one or more suppliers respectively; and
ranking, by the processing server, the one or more suppliers based on their overall scores, overall weighted scores, resulting scores of each service type, or weighted resulting scores of each service type;
wherein the supplier score report further showing the ranking of the one or more suppliers.

8. The method of claim 1, further comprising:
computing, by the processing server, resulting scores of one or more completed test orders; and
generating, by the processing server, a benchmarking report from data of the one or more completed test orders;
wherein the benchmarking report showing resulting scores of one or more completed test orders requested by the client user against resulting scores of all completed test orders of a service type selected by the client user.

9. The method of claim 8, wherein information in the benchmarking report being sorted and limited by one or more limiting scopes comprising service date of test order, service date range of test order, product category, and factory location.

10. The method of claim 1, further comprising:
receiving, by the processing server, data of a corrective action plan submitted by a supplier user, wherein the corrective action plan being associated with a completed test order.

11. A system for managing testing and auditing in a supply chain, comprising:
a processing server configured to receive data of a test order requested by a client user from a client computing device; and
a data repository configured to preserve the data of the test order;
wherein the data of the test order comprising dates of the test order, service type, product item, product category, supplier, and factories associated with the test order;
wherein the service type being a product test, a supplier inspection, a factory assessment, a social audit, or a security audit; and
wherein the dates of the test order comprising request date of the test order, service date of the test order, and report date of the test order.

12. The system of claim 11, wherein the processing server is further configured to:
generate reports from data of a plurality of test orders by characteristics of information recorded in the data; and
present the generated reports in a user interface to be displayed in the client computing device connected to the processing server.

13. The system of claim 11, wherein the processing server is further configured to:
send the data of the test order to one or more testers to execute the test order to completion; and
receive results of completed test orders from the testers; and
wherein the data repository is further configured to preserve the results of the completed test orders.

14. The system of claim 11, wherein the processing server is further configured to:
receive data of a product and process disposition to a completed test order requested by the client user from the client computing device, wherein the product and process disposition is selected from disposition options comprising overriding and accepting failure in result of the completed test order, requesting for a re-execute of the completed test order, and confirming result of the completed test order.

15. The method of claim 11, wherein the processing server is further configured to:
compute resulting scores and weighted resulting scores of one or more completed test orders associated with one or more suppliers selected by the client user; and
generate a supplier score report from the data of the one or more completed test orders;
wherein the supplier score report showing the resulting scores and weighted resulting scores of one or more completed test orders associated with one or more suppliers selected by the client user.

16. The method of claim 15, wherein each of the resulting scores is computed based on results of the one or more completed test orders of a service type, and wherein each of the weighted resulting scores is the product of one of the resulting scores and its respective pre-determined weightage.

17. The method of claim 15, wherein the processing server is further configured to:
compute overall scores and overall weighted scores of the one or more suppliers selected by the client user using the resulting scores and weighted scores of one or more completed test orders associated with the one or more suppliers respectively; and
rank the one or more suppliers based on their overall scores, overall weighted scores, resulting scores of each service type, or weighted resulting scores of each service type;
wherein the supplier score report further showing the ranking of the one or more suppliers.

18. The method of claim 11, wherein the processing server is further configured to:
compute resulting scores of one or more completed test orders; and
generate a benchmarking report from data of the one or more completed test orders;
wherein the benchmarking report showing resulting scores of one or more completed test orders requested by the client user against resulting scores of all completed test orders of a service type selected by the client user.

19. The method of claim 18, wherein information in the benchmarking report being sorted and limited by one or more limiting scopes comprising service date of test order, service date range of test order, product category, and factory location.

20. The method of claim 11, wherein the processing server is further configured to:
receive data of a corrective action plan submitted by a supplier user, wherein the corrective action plan being associated with a completed test order.
